(19) United States
(12) Patent Application Publication
(10) Pub. No.: US 2020/0237144 A1
(43) Pub. Date: Jul. 30, 2020

(54) HEATPROOF CARRIER FOR FOOD PREPARATION AND METHOD

(71) Applicants: Ian WILKINSON, Hong Kong (CN); WILKINSON CHINA LIMITED, Hong Kong (CN)

(72) Inventor: Ian WILKINSON, Hong Kong (CN)

(21) Appl. No.: 16/756,807

(22) PCT Filed: Oct. 9, 2018
(86) PCT No.: PCT/GB2018/052884

§ 371 Date: Apr. 16, 2020

(30) Foreign Application Priority Data
Oct. 16, 2017 (GB) 1716941.8

(51) Int. Cl. A47J 37/01; A21B 3/15; A47J 37/06; F24C 15/16; A47J 27/21

(52) U.S. Cl. CPC A47J 37/01; A21B 3/15; A47J 27/21175; F24C 15/16; A47J 37/0664

(57) ABSTRACT

An ovenproof carrier having an airflow passage. The ovenproof carrier includes a top unit and, formed separately, a base unit. A pair of passageways is formed by the top unit and the base unit, and the passageways are configured to cooperate to form the airflow passage when the top unit is received on the base unit.

### FIELD

The present disclosure relates in general to a heatproof carrier for preparation of food and a method of manufacturing thereof.

In particular the present disclosure relates to a heatproof carrier having an airflow passage and a method of manufacturing thereof.

### BACKGROUND

When food is heated in an oven, for example roasted, the food is generally placed in or on a heatproof carrier such as an oven dish or an oven tray. Suitably, a heatproof carrier has a food surface on which food is placed and may additionally have sidewalls to contain the food and anything that might become separated whilst cooking, e.g. food juices or matter.

Best cooking results may be achieved when hot air envelops the food so that all sides are cooked evenly. The food surface and/or the sidewalls, however, impede the flow of hot air and this may result in uneven cooking of the food. Particularly when roasting certain portions of the food may be braised or boiled rather than roasted. Accordingly, some known ovenproof carriers are provided with airflow passages, defined by holes in the carrier, to enable hot airflow through the carrier to aid the cooking process. A known heatproof carrier is described in CN 112706230 A. FIG. 1 shows a cross-sectional view of the known heatproof carrier 1. An aperture 5 is covered by a hood 4, thus reducing loss of food juices and matter.

Heatproof carriers such as the known heatproof carrier may be manufactured using a stamping process which provides a cost-efficient manufacturing process. According to this process the aperture 5 is formed by a die displacing material, and the hood 4 is formed from the material so displaced. As can be seen in FIG. 1, the aperture 5 and the hood 4 have identical overlap along a vertical direction. This provides a limitation resulting in the hood 4 being matched in location along the carrier and in size to the location and size of the aperture 5. This limitation may in use reduce the effectiveness of the hood 5, particularly as regards wet roasting where a large amount of liquid may be released.

### SUMMARY

According to an exemplary embodiment, there is provided a heatproof carrier for preparation of food. An airflow passage through the carrier is defined by a pair of passageways, the first of which is formed by a top unit and the second of which is formed by a base unit. The top unit and the base unit are formed separately which allows the passageways to be offset relative to each other. By offsetting the passageways, for example along the carrier, loss of food juices or matter may be reduced. Further, forming the top unit and the base unit separately allows forming either or both using a stamping process and, hence, is capable of being manufactured cost-effectively.

Accordingly there is provided an exemplary heatproof carrier for preparation of food, the carrier comprising: a top unit defining a top face of the carrier and, formed separately, a base unit defining a rear face of the carrier; the top unit forming a first passageway, the base unit forming a second passageway; wherein the base unit is configured to receive the top unit, and when so received: the first passageway and the second passageway cooperate to define an airflow passage between the top face and the rear face, and the first passageway is offset relative to the second passageway. In the exemplary embodiments the first passageway forms a fluid path that extends from the top face to an opposed face of the top unit and the second passageway forms a fluid path that extends from the rear face to an opposed face of the base unit. In preferable embodiments, the passageways are not orthogonal to the top face and rear face.

The first passageway and the second passageway may be offset along any suitable direction. For example, there may be provided a vertical separation between the first passageway and the second passageway. Additionally or alternatively, the passageways may be offset along the carrier, i.e. along a horizontal direction. Moreover, the passageways may be offset by sizing them differently and, in particular, making the second passageway smaller than the first passageway. Thus the first passageway and the second passageway being offset relative to another is considered to include at least these listed examples for spatially configuring the carrier to promote airflow and, at the same time, reduce loss of food juices and matter.

Preferably the first passageways are a plurality of passageways. Preferably the second passageways are a plurality of passageways. In the exemplary embodiments one or both of the first and second passageways are formed in a grid array. Here, the grid array may include a linear grid that extends in a first direction, for example elongate slots, or the grid array may include a two-dimensional grid that extends in both a first direction and a second direction. Whilst preferably the grid may be a uniform pattern, non-uniform patterns are also a possibility. By forming a plurality of first and second passageways that are arranged over a large area of the rear and top faces, the advantageous airflow is provided across a wide area of the food surface.

According to some examples, there is provided a cover for covering the first passageway. The cover is configured to extend above the first passageway and to define a covered passageway along the top face. The covered passageway thus defined cooperates with the first passageway to extend the airflow passage.

It is considered convenient to provide the cover to prevent food from sealing the first passageway. In use, food is placed on the top face of the carrier and may thus seal the first passageway and so inhibit airflow. By providing the cover, food placed on the top face is generally prevented from sealing the first passageway. Moreover, as the cover extends above the first passage, loss of food juices and matter may be reduced or further reduced because it will be prevented from dripping or falling along a vertical direction into the first passage.

According to some examples, the cover is a hood formed on the top unit. The hood possesses an opening towards a first side and may be closed towards other sides thereof. With an opening towards a single side of the cover, loss of food juices or matter may be reduced or further reduced.

According to some examples, a raised threshold is formed on the top unit for inhibiting flow of liquid along the top face of the carrier. The raised threshold is located in front of the opening of the hood and thus configured to inhibit particularly flow into the airflow passage. Loss of food juices and matter may thus be reduced or further reduced by providing the raised threshold at the opening of the hood. More generally, however, the raised threshold can be provided with any type of cover. The raised threshold may be any suitable protrusion providing an elevation to the top unit.

According to some examples, the top unit comprises a raised region, a lower region. An inclined region extends between the upper region and the lower region. Such a configuration defines a preferred direction for flow of liquid, i.e. towards the lower region. Liquid may be prevented from pooling, thus reducing or further reducing loss of food juices through the airflow passage. Moreover, the cover may be closed towards the upper region, thus providing a closed side facing a flow of liquid. Thus the cover and the inclination of the top unit are configured to cooperate to further reduce loss of food juices.

According to some examples, the top unit comprises a guidance channel for conveyance of liquid along the top unit. Where the top unit comprises the upper region and the lower region, the guidance channel suitably extends between the upper region and the lower region. Whilst an inclination of the top unit, as introduced by providing the upper and lower regions, provides for a preferred direction for liquid flow, the guidance channel provides a preferred path for liquid flow. Particularly in combination with the inclination, the guidance channel provides means for effectively transporting liquid across the top unit and reducing or further reducing loss thereof into the airflow passage. According to an example, the guidance channel is embossed into the top unit.

According to some examples, a raised periphery is formed on the base unit for inhibiting a flow of liquid into the second passageway. The raised periphery extends about the second passageway and is configured to form a barrier to the flow of liquid. The raised periphery may be formed in the immediate periphery of the second passageway or, alternatively, may be formed in the general vicinity of the second passageway. Conveniently, the raised periphery extends around the second passageway to provide a barrier to liquid flow from all directions along the base unit.

According to some examples, a collection channel is formed. The collection channel may be suitable for collecting food juices and/or matter which becomes separated during the cooking process. Suitably, the collection channel extends along the base unit. The collection channel may be used as a reservoir of food juices, for example to aid the cooking process, but also prevents food juices from overflowing from the carrier and potentially dirtying an oven or other cooking apparatus.

According to some examples, the top unit comprises a skirt. The skirt is a generally downwardly extending protrusion, where a downwards direction is from the top face of the carrier to the rear face of the carrier. Where the base unit includes the collection channel, the skirt may be configured to be received into the collection channel. This arrangement may be particularly convenient, as it allows food or food juices from the top unit to quickly collect in the collection channel.

According to some examples, the first passageway and the second passageway are arranged to be aligned when the top unit is received by the base unit. Where the top unit comprises the skirt and the base unit comprises the collection channel, the passageways may be aligned when the skirt is received into the collection channel. In an aligned configuration, the first passageway and the second passageway possess overlap along the vertical direction. Nevertheless the passageways remain offset, for example by having partial overlap along the vertical direction only or by being offset along the vertical direction.

According to some examples, the top unit comprises a plurality of first passageways and the base unit comprises a plurality of second passageways, and wherein each first passageway is configured to be aligned with a corresponding second passageway when the skirt is received into the collection channel.

According to some examples, the second passageway has a diameter which is smaller than a diameter of the first passageway.

According to some examples, the top unit is fastened to the base unit. Although formed separately, the top unit and the base unit may be joined together. The units may be joined permanently, for example by welding, or semi-permanently, for example using an adhesive, or selectively, for example through a releasable fastening mechanism.

There is also provided an exemplary method of manufacturing a heatproof carrier for preparation of food. The method comprises: providing a top unit configured to form a top face of the carrier, stamping the top unit to form a first passageway, providing a base unit configured to form a rear face of the carrier, stamping the base unit to form a second passageway, wherein the first passageway and the second passageway are configured to cooperate to form an airflow passage through the carrier when locating the top unit on the base unit.

According to some examples, stamping the top unit comprises forming a hood extending above the first passageway to define a covered passageway along the top face.

### BRIEF DESCRIPTION OF DRAWINGS

FIG. 1 shows a cross-sectional view of known example of a heatproof carrier.

For a better understanding of the invention, and to show how example embodiments may be carried into effect, reference will now be made to the accompanying drawings in which:

FIG. 2 shows an exploded perspective view of an exemplary heatproof carrier;

FIG. 3 shows a perspective view of an example heatproof carrier comprising a top unit and a base unit;

FIG. 4 is a perspective view of the top unit;

FIG. 5 is a perspective view of the base unit;

FIG. 6 shows a partially broken-away perspective view of the heatproof carrier;

FIG. 7 shows a cross-sectional view of an airflow passage of the heatproof carrier;

FIG. 8 illustrates a method of manufacturing a heatproof carrier;

FIG. 9 shows a perspective view of a further embodiment of a heatproof carrier;

FIG. 10 shows a cross-sectional view through the heatproof carrier of FIG. 9;

FIG. 11 shows a perspective view of yet another embodiment of a heatproof carrier with the top unit separated from the base unit;

FIG. 12 shows a perspective view of the embodiment of FIG. 11 with the top unit carried on the base unit; and

FIG. 13 shows a perspective view of another embodiment of a heatproof carrier with the top unit separated from the base unit; and

FIG. 14 shows a perspective view of the embodiment of FIG. 13 with the top unit carried on the base unit.

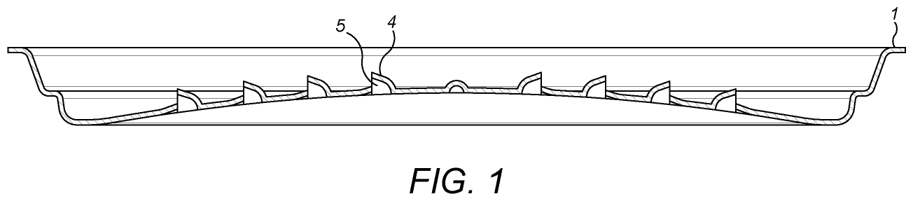

### DESCRIPTION OF EMBODIMENTS

At least some of the following example embodiments provide an improved heatproof carrier for preparation of food. The example device is straightforward to manufacture and convenient for the user. Many other advantages and improvements will be discussed in more detail herein.

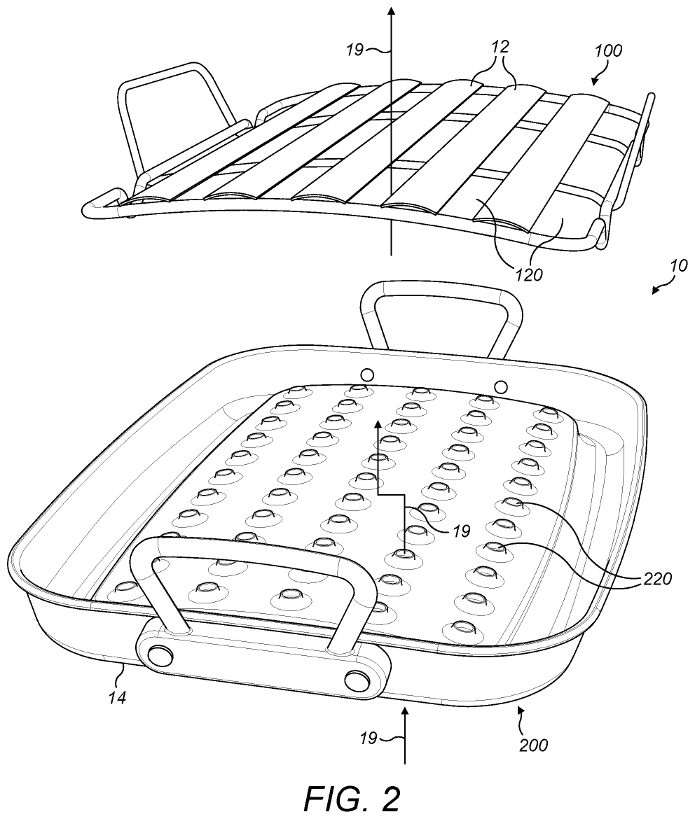

FIG. 2 shows an example heatproof carrier 10. The heatproof carrier 10 is formed from a top unit 100 and a separately formed base unit 200. The top unit defines a top face 12. The base unit defines a rear face 14. A plurality of first passageways (120) are formed in the top unit. In FIG. 2, the first passageways are defined by spaces between the bars forming the top face. A plurality of second passageways 220 are formed in the base unit. The top unit is received by the base unit such that the top face and rear face are spaced apart, wherein the first and second passageways are offset relative to each other and such that the first and second passageways combine with the spacing between the top face and rear face to define airflow passages. In FIG. 2, the airflow passage is depicted by arrow 19.

The heatproof carrier 10 having airflow passages is for preparing food such as for example meat, poultry, vegetable, pie or pizza. The heatproof carrier may alternatively be referred to as a roasting tray, a roasting tin, or simply a roaster. Conveniently, the heatproof carrier is suitable for use with a domestic oven and may be sized accordingly. In some examples, the heatproof carrier is suitable for a commercial oven or various types of barbeques. Suitably, the heatproof carrier is suitable for any conventional type of heat sources, including a fan-assisted oven or a gas flame of a grill and it will be appreciated the carrier will be sized accordingly. A distinction can be made between dry roasting of, for example, a pizza, and wet roasting of, for example, a meat joint. In dry roasting, limited juices tend to be created. In wet roasting, juices tend to be expelled from the food during roasting. In dry roasting it is beneficial to prevent the food from blocking the airflow passages. In wet roasting it is beneficial to prevent the juices from escaping through the airflow passages, for instance by dripping out of the carrier onto the bottom of the oven or onto the BBQ coals.

The carrier 10 may have any suitable shape possessing a top face 12 and, opposite thereto, a rear face 14. The top face is arranged to receive food to be cooked thereon. It will be appreciated that, dependant on the cooking application, a lid or cover may be supplied and/or used with the carrier so that the food is enclosed between the cover and top face 12 as is known in the art. Moreover, as is known in the art, the carrier 10 may be provided with carrying handles or other common features of known roasters.

According to some examples the carrier may have a shape which is, for example, round or oval or some polygonal shape. According to the present example the carrier is rectangular. An elongate side 16 extends along a first horizontal direction, while a short side 18 extends along a second horizontal direction, wherein the first horizontal direction and the second horizontal direction are perpendicular.

The heatproof carrier 10 is configured to expose food to direct heat from all sides, thereby achieving a cooking result that may be considered more flavoursome and/or may improve on cooking time. Suitably, the heatproof carrier comprises an airflow passage 19. The airflow passage enables heated air to flow around the food during the cooking process. In particular, heated air may reach food from below through the airflow passage. Additionally or alternatively, moisture released during the cooking process may escape through the airflow passage.

According to the present example, a plurality of airflow passages is defined by the carrier.

The heatproof carrier 10 comprises a top unit 100 and a base unit 200. The top unit includes at least one first passage and the base unit includes at least one second passageway, wherein the top unit is spaced from the bottom unit and the first and second passageways are not caused to overlap in a plan view, thereby creating the airflow passage. Thus, by forming the carrier from two parts the airflow passages can be created by readily available manufacturing processes. It will be appreciated, that in dry cooking applications, where juices are not a concern, the top surface may be substantially flat. Moreover, the base unit may also be substantially flat. Alternatively in wet cooking applications, where juices are a concern, the top surface may be shaped or profiled to encourage juices to drain to a collection or storage area. Moreover, the base unit may also be shaped or profiled to drain juices away from apertures to the second passages.

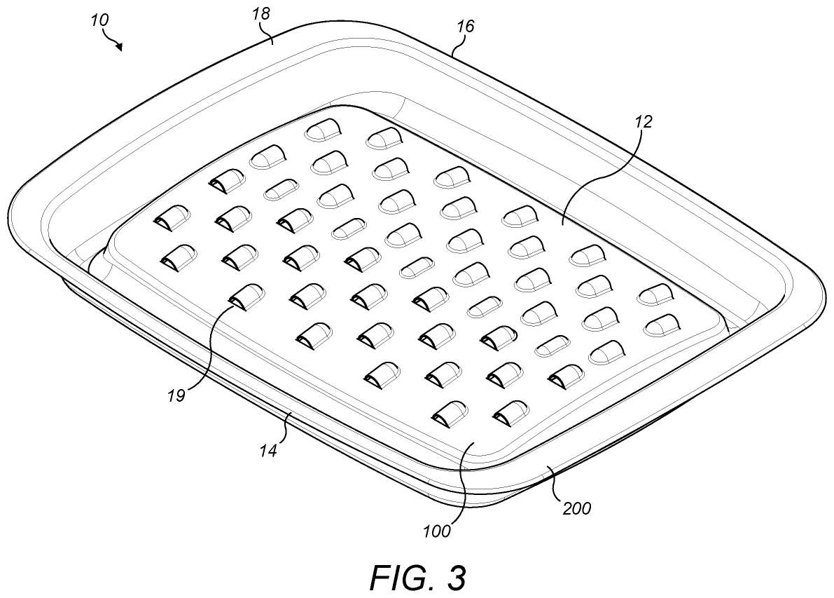

FIGS. 3 to 5 show an exemplary heatproof carrier 10 formed in two parts by a top unit 100 and a base unit 200.

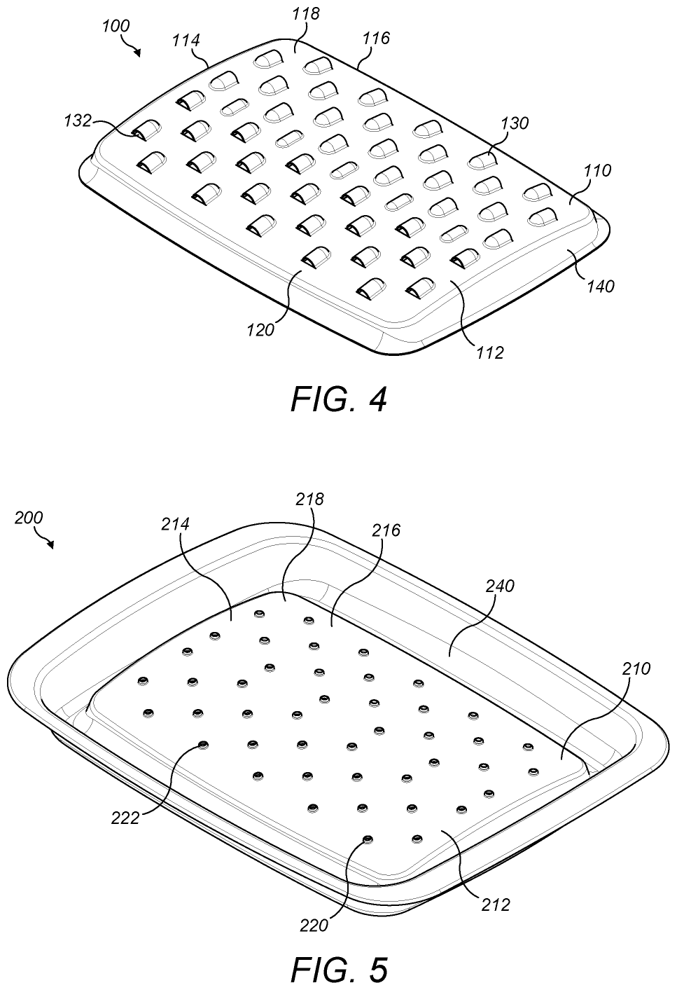

Shown in FIG. 4, the top unit 100 has an upper surface 110 and, opposite thereto, an underside 112. The upper surface defines the top face 12 of the carrier and so, in use, receives food to be cooked. According to the present example, the upper surface comprises a raised region 114, a lower region 116 and an inclined region 118 extending between the raised region and the lower region. Thus the upper surface is arched or inclined, defining a preferred direction for the flow of liquid along the upper surface. More particularly, the liquid will flow from the raised region to the lower region under gravity.

Conveniently, the inclined upper surface 110 may be particularly suitable for foods which release a relative large volume of liquid during the cooking process. For example, the inclined supper surface may be particularly suitable for cooking meat.

The top unit 100 comprises a first passageway 120. The first passageway extends through the top unit and, in use, enables airflow through the top unit. The first passageway connects the upper surface 110 and the underside 112.

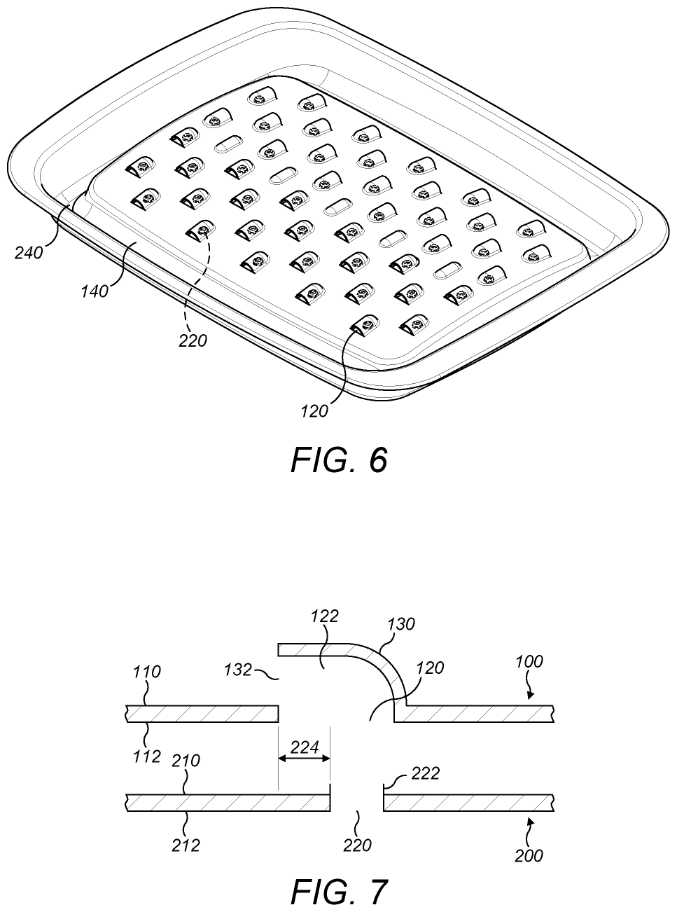

The top unit 100 comprises a cover 130. The cover extends from the upper surface 110 and is arranged to cover the first passageway 120. The cover also extends along the upper surface, thus defining a covered passageway 122 (shown in FIG. 6). The covered passageway is an extension of the first passageway but, while the first passageway extends through the top unit, the covered passageway extends along the top unit.

The cover 130 according to the present example has a single opening 132. A cover that possesses a single opening is alternatively referred to as a hood. The cover has a generally cylindrical shape with a rounded end and an open end, the open end corresponding to the opening 132.

The opening 132 of the cover 130 is directed towards the lower region 116 of the upper surface 110. Towards the raised region 114 the cover is closed, thus forming a barrier to a flow of liquid along the preferred direction. According to the present example, the cover is also closed towards either side and therefore possesses a single opening in a single direction only.

The top unit 100 comprises a skirt 140. The skirt extends from the upper surface 110 in a generally downwardly direction, as defined in relation to the carrier 10, i.e. from the top face 12 towards the rear face 14. The skirt is configured to be received by the base unit 200 and, when so received, support the upper surface. According to the present example, the skirt extends around the entire periphery of the upper surface.

FIG. 5 shows a perspective view of the base unit 200.

The base unit 200 has an upper surface 210, which is referred to as a topside 210. The base unit also comprises an underside 212, which is referred to as an underside 212. The topside and the underside are opposite surfaces of the base unit. The topside faces the underside 112 of the top unit 100 when the top unit is carried by the base unit.

The topside 210 possesses the same inclination as the upper surface 110 of the top unit 100. That is, the topside comprises a raised region 214, a lower region 216 and an inclined region 218 extending between the raised region and the lower region.

The base unit 200 comprises a second passageway 220. The second passageway extends through the base unit and, in use, enables airflow through the base unit. More particularly, the second passageway connects the topside 210 and the underside 212.

A raised periphery 222 is formed on the topside 210. The raised periphery extends about the second passageway 220 and is arranged as a barrier to a flow of liquid along the topside. According to the present example, the raised periphery surrounds the second passageway.

The base unit 200 comprises a collection channel 240. The collection channel extends around the topside 210 and is configured to receive food juices and matter which may become separated from the food during the cooking process. Suitably, the collection channel receives the skirt 140 of the top unit 100 so that, in use, the food juices or matter collect in the collection under gravity.

FIG. 6 shows a perspective view of the heatproof carrier 10 in which the top unit 100 is depicted transparent to expose otherwise obstructed parts of the base unit 200.

As can be seen in FIG. 6, when the skirt 140 is received into the collection channel 240, the first passageway 120 and the second passageway 220 are aligned. That is to say, the first passageway and the second passageway possess overlap along the vertical direction. Nevertheless, the first and second passageway are offset in the sense that they are disjointed.

The first passageway 120 and the second passageway 210 are configured to cooperate so that airflow through the first passageway may also flow through the second passageway, and vice versa. That is, the first and second passageway are arranged to cooperate to form the airflow passage 19 through the carrier 10. More particularly, the airflow passage enables airflow between the top face 12 and the rear face 14 of the carrier. In use, hot air can rise through the airflow passage to reach food being cooked thereon. Similarly, moisture released from the food can escape through the airflow passage to the rear face.

FIG. 7 shows a cross-sectional view of the airflow passage 19.

In FIG. 7 the top unit 100 and the base unit 200 are depicted as vertically separated, but according to some examples the lower surface 112 of the top unit meets the topside 210 of the base unit.

A raised threshold may be formed on the upper surface 110 of the top unit 100 (not shown in Figures). Here, the raised threshold is located before the opening 132 of the cover 130 and provided as a barrier. That is, the raised threshold inhibits liquid from flowing along the upper surface and into the first passageway 120.

According to the present example, the second passageway 220 has a diameter which is smaller than the diameter of the first passageway 120. Suitably, the second passageway is recessed away from the opening 132 of the cover. A clearance space 224 is thus defined between the opening of the cover and the second passageway. Said clearance space may reduce or further reduce the loss of liquid through the second passageway. It is noted that liquid which flows along the top unit and enters the first passageway will tend to stick to the top unit due to surface tension of the liquid. Accordingly, this liquid will tend to travel along lower surface 112 and tend not to flow or drip into the second passageway.

As shown in FIG. 7, the opening 132 of the cover 130 is offset from the second passageway. According to the present example, the opening and the second passageway 220 possess no overlap along the vertical direction when the top unit is located on the base unit. More generally, either the opening of the cover or the first passageway 120 is offset from the second passageway in order to reduce or further reduce loss of liquid through the airflow passage.

The heatproof carrier may be formed from any suitable choice of material. A suitable choice of material may include, for example, stainless steel or aluminium. In general, the top unit 100 may be made from a different material than the base unit 200. Using an appropriate choice of material, the carrier may not only withstand heat but also repeated and thorough cleaning. Conveniently, the heatproof carrier is dishwasher suitable and is dimensioned to fit into a domestic or industrial dishwasher. More particularly, the top unit 100 and the base unit 200 are separately washable.

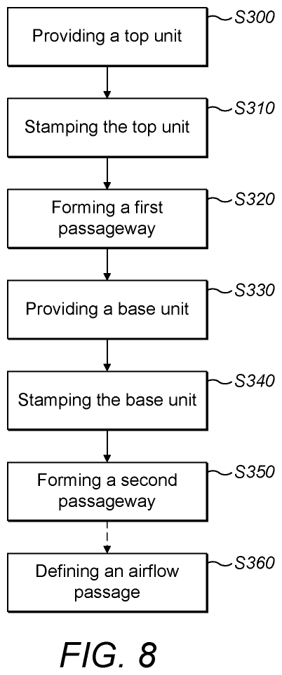

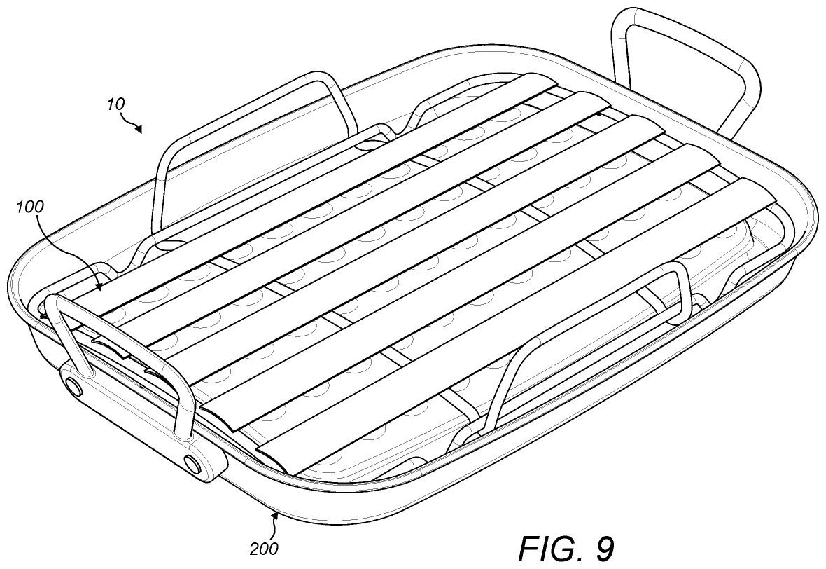

FIG. 8 illustrates a method of manufacturing a heatproof carrier according to the present disclosure.

The method comprises providing a top unit (S300). The method further comprises stamping (S310) the top unit to form a first passageway (S320). The first passageway extends through the top unit. Alternatively, the top unit may be formed by joining slats to a wire frame or other support as herein described.

The method also comprises providing a base unit (S330). The method further comprises stamping (S340) the base unit to form a second passageway (S350). The second passageway extends through the base unit. Suitably, the apertures can be formed through the base using simple fabrication processes. Moreover, because simple stamping or casting or other fabrication methods of forming a base with holes can be employed, the base can be made of a wide range of materials, for instance the base may be cast in a heavy duty material suitable for use on a BBQ.

The top unit and the base unit are configured to cooperate to define the top face and the rear face, respectively, of the heatproof carrier when locating the top unit on the base unit. Moreover, the first passageway and the second passageway are configured to cooperate to form an airflow passage through the carrier when the top unit is located on the base unit (S360).

According to the present example, the stamping of the top unit also includes forming a hood extending above the first passageway to define a covered passageway along the top face. Using a suitable choice of die the first passageway and the hood are formed in a single manufacturing step.

According to other examples, the upper surface 110 of the top unit 100 is formed by lattice of slats (or ‘strips’), while a gap between the adjacent slats corresponds to the first passageway. Suitably, when the top unit is carried on the base unit, each slat covers a row of second passageways. That is, a slat overlaps along the vertical direction with at least one second passageway. Thereby the slat is configured to define a cover, which need not be formed separately. Conveniently, the gap between adjacent slats, i.e. the first passageway, has no overlap along the vertical direction with a second passageway.

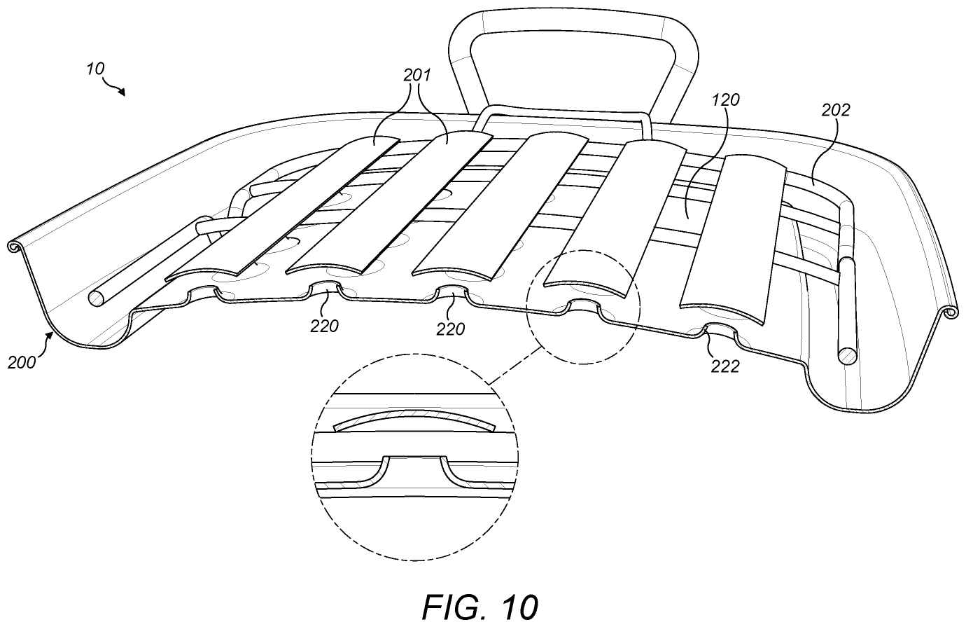

For instance, referring to FIGS. 9 and 10 an alternative embodiment of a heatproof carrier 10 is shown. The same reference numbers have been used for like parts with the previous embodiments and those features may be substantially as herein described. The heatproof carrier 10 is formed from two separate parts, a top unit 100 and a base unit 200. The base unit is formed in a generally tray configuration, wherein a raised central section of the base unit is provided so as to generate a collection channel 240 (or ‘well’) around the edge to collect juices. However, as will be appreciated from the features described herein, the exact shape and configuration of the base unit will be dependent on the intended use.

The raised central section includes a plurality of apertures 220. The plurality of apertures are provided in a grid like pattern. Suitably the grid pattern of apertures 220 spans a substantial part of the rear face of the base unit. By covering a substantial area of the rear face, the advantageous airflow is provided to a wide area and multiple points. As herein explained, a raised collar 222 can be provided around each aperture to prevent juices from flowing there through. Suitably, the apertures may be punched in a straight forward manufacturing process.

In FIGS. 9 and 10, the top unit is formed from a plurality of slats 201 that are arranged to cover the apertures in the base unit. Each slat 201 is connected to the others to form one or more integral units. Suitably, the slats 201 are shown connected by a frame 202. Gaps between the slats 201 form the first passageways 120. The slats 201 may have a substantially flat top face, each top face of a slat combining to form the top face of the top unit that receives the food. Alternatively, the slats may have a shaped or profiled face, for instance, the faces are shown as being convex across the length of the slats.

Handles may be provided on the base unit and/or the top unit as is known in the art to aid removal and handling.

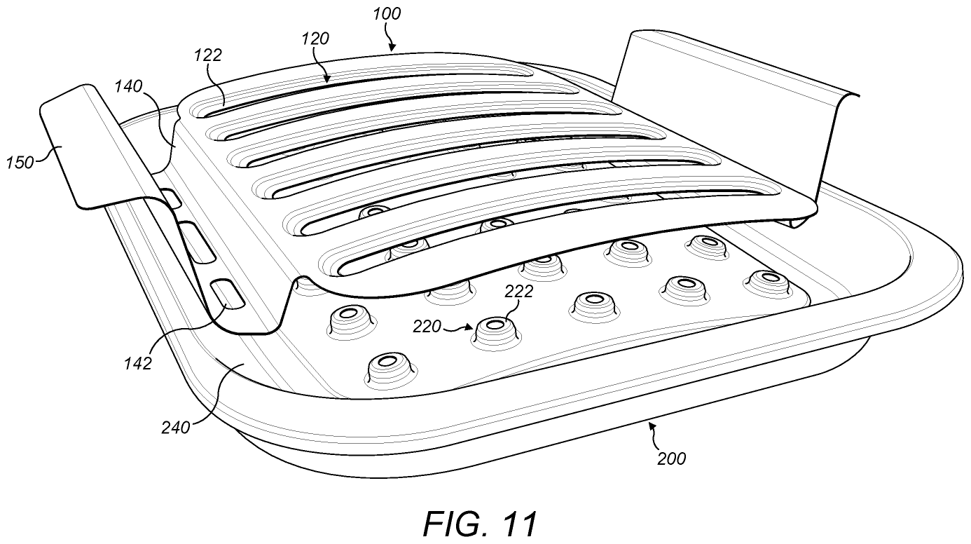

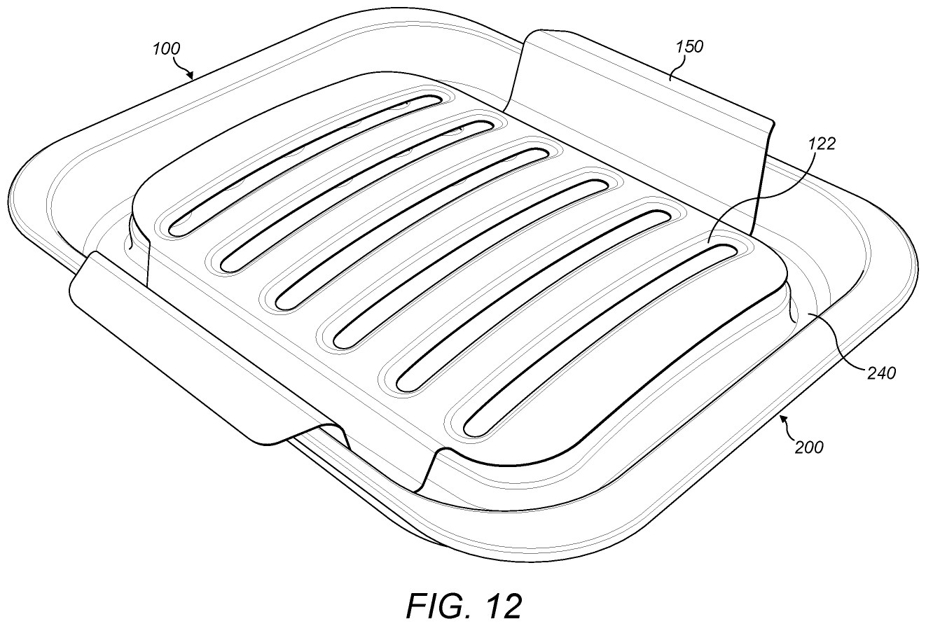

In FIGS. 11 and 12, yet another embodiment of a heatproof carrier 10 is shown. The same reference numbers are used for like parts with the previous embodiments and those features may be substantially as herein described. The heatproof carrier 10 is formed from two separate parts, i.e. a top unit 100 and a base unit 200.

The base unit 200 is generally similar to the base unit 200 described with reference to FIG. 2. In particular, a plurality of apertures 220 is formed in the base unit 200 to define second passageways 220. The apertures 220 may have any suitable shape, such as elongate (i.e. slots) or rounded. According to the present example, the apertures 220 are circular. The apertures 220 are arranged in a grid-like pattern, thereby defining rows of apertures 200. Raised collars 222 may be provided around each aperture 220.

The top unit 100 comprises a plurality of slats 201 which are formed integrally and configured to define a plurality of slots 120, i.e. elongate apertures, between adjacent slats 201. That is to say, the top unit 100 may be a single piece provided with slots 120 therein. For example, a sheet of metal may be punched to form the slots 120 as part of a manufacturing process, but any other suitable manufacturing process may be used alternatively.

The top unit 100 is configurable to rest on the base unit 200 so that the apertures 200 are covered by slats 201. For example, each slat 201 may cover a row of apertures 200.

According to the present example, a slot 120 is defined by an inverted collar 124 of the top unit 100 which extends about the slot 120. Here, ‘inverted’ is understood with respect to the raised collar 222 of the base unit 200. That is to say, while the raised collar 222 extends into a first direction, e.g. upwardly, the inverted collar 124 extends into a second direction that is generally opposite to the first direction, e.g. downwardly. The inverted collar 124 may guide fluids past raised collars 222 of the base unit 200 so that fluid loss through the apertures 220 is minimised.

Openings 142 (or ‘holes’) are provided in the skirt 140. According to the present example, the skirt 140 is configured to extend through the collection channel 240. Accordingly, liquids may gather on the skirt 140. Removing the top unit 100 from the base unit 200 may cause such liquids, which could potentially be hot, to be spilled. Similarly, liquids gathered in the collection channel 240 could be splashed by placing the placing the skirt 140 within the collection channel 240. By providing the openings 142, liquids may pass through the skirt 140 so that spilling or splashing of liquids may be minimised.

According to the present example, the top unit 100 comprises a pair of handles 150. Each handle 150 extends from the skirt 140 or a respective skirt portion 140.

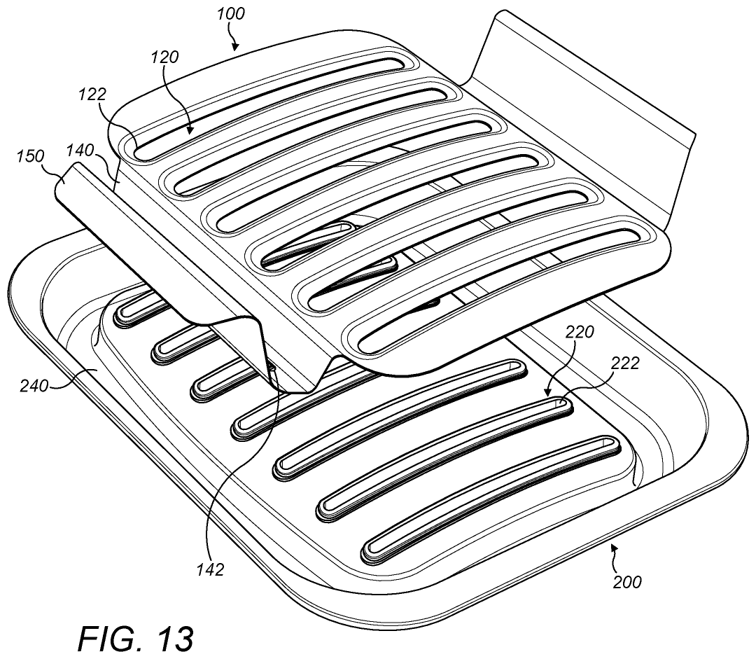

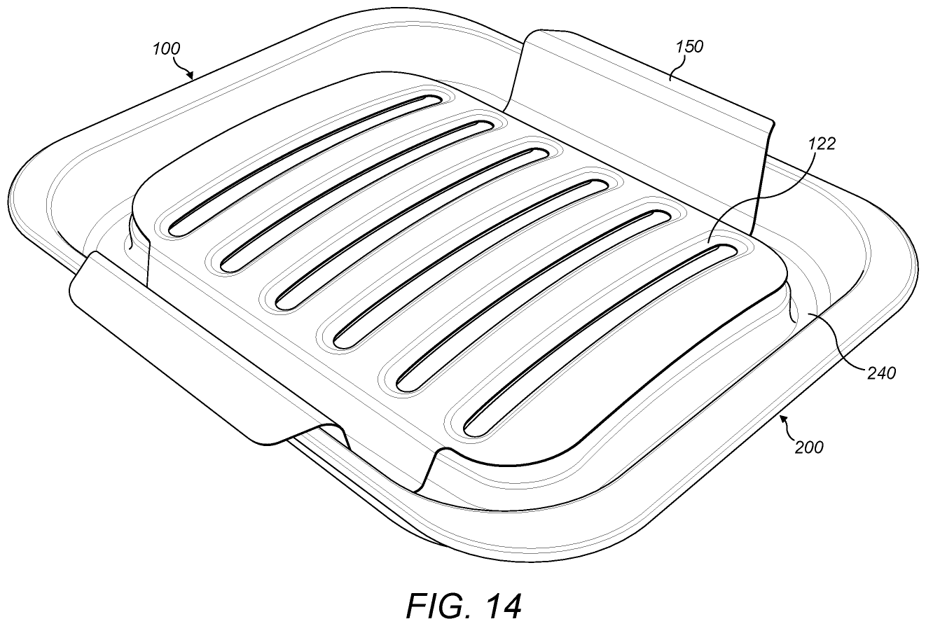

FIGS. 13 and 14 show another exemplary heatproof carrier 10. The heatproof carrier 10 shown in FIGS. 13 and 14 generally corresponds to the heatproof carrier 10 of FIGS. 11 and 12. According to the present example, however, the apertures 220 of the base unit 200 are elongated to define slots 220. That is to say, the rows of apertures 220 of the example of FIGS. 11 and 12 have been replaced by slots according to the example of FIGS. 13 and 14.

According to other examples, the cover 130 may have a different shape. In particular, the cover may have a generally flat top. Conveniently, a flat top may be particularly suitable for supporting certain kinds of food such as, for example, pizza. Where a plurality of flat topped covers is provided, food may be suspended between the covers, rather than sagging, and piercing of the food may be prevented.

According to other examples, the second passageway 220 may be provided with a cover. The cover may be as described in relation to the first passageway 120.

In summary, exemplary embodiments of a heatproof carrier have been described. The heatproof carrier may be manufactured industrially. An industrial application of the example embodiments will be clear from the discussion herein.

Although preferred embodiment(s) of the present invention have been shown and described, it will be appreciated by those skilled in the art that changes may be made without departing from the scope of the invention as defined in the claims.

1. A roasting tray for preparation of food, the tray comprising:
a top unit defining a top face of the tray and, formed separately, a base unit defining a rear face of the tray;
the top unit forming a first passageway,
the base unit forming a second passageway;
wherein the base unit is configured to receive the top unit, and when so received:
the first passageway and the second passageway cooperate to define an airflow passage between the top face and the rear face, and
the first passageway is offset relative to the second passageway.

2. The roasting tray according to claim 1, comprising a cover extending above the first passageway and configured to define a covered passageway along the top face, wherein the covered passageway cooperates with the first passageway to extend the airflow passage.

3. The roasting tray according to claim 2, wherein the cover is a hood formed on the top unit.

4. The roasting tray according to claim 1, comprising a raised threshold formed on the top unit, wherein the cover defines an opening on the top unit and the raised threshold is located in front of the opening.

5. The roasting tray according to claim 1, the top unit comprising a raised region, a lower region and an inclined region extending between the upper region and the lower region.

6. The roasting tray according to claim 5, the top unit comprising a guidance channel for conveyance of liquid along the top unit, the guidance channel extending from the upper region to the lower region.

7. The roasting tray according to claim 1, comprising a raised periphery formed on the base unit, the raised periphery extending about the second passageway and configured to form a barrier to a flow of liquid into the second passageway.

8. The roasting tray according to claim 1, comprising a collection channel for collecting food juices, the collection channel extending along the base unit.

9. The roasting tray according to claim 8, wherein the top unit comprises a skirt configured to be received into the collection channel when the top unit is received by the base unit.

10. The roasting tray according to claim 9, wherein the first passageway and the second passageways are aligned when the skirt is received into the collection channel.

11. The roasting tray according to claim 10, wherein the top unit comprises a plurality of first passageways and the base unit comprises a plurality of second passageways, and wherein each first passageway is configured to be aligned with a corresponding second passageway when the skirt is received into the collection channel.

12. The roasting tray according to claim 1, wherein the second passageway has a diameter which is smaller than a diameter of the first passageway.

13. The roasting tray according to claim 1, wherein the top unit is fastened to the base unit.

14. (canceled)

15. (canceled)
